(19) United States
(12) Patent Application Publication
(10) Pub. No.: US 2002/0041683 A1
(43) Pub. Date: Apr. 11, 2002

(54) Method for selecting optimal number of prime factors of a modulus for use in a cryptographic system

(76) Inventors: Dale W. Hopkins, Gilroy, CA (US); Tom W. Collins, Saratoga, CA (US)

Correspondence Address: Leah Sherry, Esq., OPPENHEIMER WOLFF & DONNELLY LLP, 1400 Page Mill Road, Palo Alto, CA, 94304-1124, US

(21) Appl. No.: 09/967,425

(22) Filed: Sep. 27, 2001

Related U.S. Application Data
(60) Provisional application No. 60/239,399, filed on Sep. 29, 2000.

(51) Int. Cl. H04K 1/00

(52) U.S. Cl. 380/28

(57) ABSTRACT

A method provided for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a determined level of security.

### CROSS REFERENCE TO RELATED APPLICATIONS

Reference is made and priority claimed to U.S. Provisional Patent Application Serial No. 60/239,399, filed on Sep. 29, 2000, entitled “Method for Selecting Optimal Number of Primes in an RSA Multi-Prime Cryptographic System.” Reference is also made to U.S. patent application Ser. No._______, filed on_______, entitled “Multiple Prime Number Generation Using a Parallel Prime Number Search Algorithm.” Further reference is made to U.S. Pat. No. 5,848,159, filed on Dec. 8, 1998, entitled “Public Key Cryptographic Apparatus and Method”, which is incorporated by reference.

### BACKGROUND OF THE INVENTION

1. Field of the Invention

The present invention relates generally to cryptographic systems, and more specifically to a method and apparatus for optimizing computational performance and security in a Multi-Prime cryptographic system using a modulus having greater than two constituent prime factors.

2. Description of the Prior Art

In a typical cryptographic scheme, an encryption process is performed to transform a plaintext message M into ciphertext C, and a decryption process is performed to transform the ciphertext C back into the plaintext message M. In a public key cryptographic scheme, encryption and decryption processes are performed using a pair of cryptographic keys that are produced based on large prime numbers that meet certain criteria. In the most common type of public key cryptographic application, a public key E defined as the pair {e, n} is used to encrypt a message into ciphertext, and a private key D defined as the pair {d, n} is used to decrypt the ciphertext. It is important to note that the public key E, which may be publicly known, cannot be used to decrypt the ciphertext. Only the private key D, which is kept secret, can be used for decryption of a message encrypted by the public key D. As an example, consider that a sender needs to send an encrypted message M to a recipient. The recipient publishes his or her public key, making it known at least to the sender, and keeps his or her private key secret. The sender then uses the public key E to encrypt a message, and send the encrypted message to the recipient who then uses the private key to decrypt the message. As further explained below, although the public key is related to the private key, it is extremely difficult to determine the private key from the public key.

One example of a public key cryptography system is the classic two-prime “RSA” scheme which capitalizes on the relative ease of generating a composite number from the product of two large prime numbers, as compared with the difficulty of factoring a composite number into its constituent prime numbers. The classic two-prime RSA scheme uses the public key E including a composite number n and a number e, where n is defined by relationship (1), below.

n=p·q (1)

where the factors p and q are different prime numbers, and e is a number relatively prime to (p−1) and (q−1). Importantly, the sender has access to the public key E (including n and e), but not to the prime factors p and q.

The sender enciphers a message M to create ciphertext C by computing the exponential relationship (2), below.

C≡M^{e}(mod n) (2)

wherein the number e provides a public exponent (or encryption exponent), and the composite number n provides a modulus. The recipient of the ciphertext C may decrypt the message M using the private key D, which includes a number d and the modulus n, in accordance with relationship (3), below.

M≡C^{d}(mod n) (3)

The number d, which provides a private exponent (or decryption exponent), is a multiplicative inverse of

e(mod(lcm((p−1), (q−1)))) (4)

so that

e·d≡(mod(lcm((p−1), (q−1)))) (5)

where lcm((p−1), (q−1)) is the least common multiple of the numbers (p−1) and (q−1).

Most implementations of the RSA cryptography scheme employ a different relationship that is although equivalent to relationship (6), below, for determining the private exponent.

d≡e⁻¹mod ((p−1)(q−1)) (6)

The security of a cryptography system relies on the fact that the prime factors p and q of the composite number n are required to decrypt the ciphertext C, and it is computationally difficult to factor the composite number n into its constituent prime factors p and q.

The following example provides an overview of use of the two-prime RSA encryption and decryption processes. If a recipient wants to receive an encrypted message from a sender, the recipient must choose two large random prime numbers, p and q, which are kept secret. A modulus n is computed based on p and q in accordance with relationship (1) above. The encryption exponent e is then chosen, and the modulus n and encryption exponent e become the “public key” of the RSA cryptosystem. This public key is conveyed to the sender. The recipient computes the secret decryption exponent d to satisfy relationship (5) above. The decryption exponent d and the modulus N become the secret key D, which is retained by the recipient and is not distributed to the sender or any other possible user.

When the sender wants to send an encrypted message to the recipient, the sender obtains the recipient's public key e and converts her plaintext message, M, into a ciphertext message, C, which is computed in accordance with relationship (2) above. The sender sends the ciphertext to the recipient who later decrypts it using his secret key D in accordance with relationship (3) above.

In this system, the public exponent e typically is chosen as small (e=3 or e=65537). This means that the private exponent d which satisfies relationship (4) may be on the order of size, or length L (in bits) of the modulus n. The result is that the sender has a “small” computation to encrypt the message while the recipient has to execute a computationally intensive formula to compute the plaintext message, M. Because the recipient can choose to retain the prime factors p and q, he can choose to implement the Chinese remainder theorem to increase the performance of this computation as further explained below.

As further explained in detail below, it is important to note that a sender of an encrypted message is not affected if the recipient chooses to use more than two prime factors to form the modulus n. If a recipient chooses n=p * q * r * s (the product of four primes), then the sender's computations do not change. The sender is not aware that the recipients modulus consists of more than two primes or whether he chooses to use the Chinese remainder theorem.

Because each of the relationships (2) through (6) define an exponentiation, a large amount of time and processing resources are required to execute instructions for implementing relationships (2) through (6). In order to accelerate the encryption and/or decryption processes, conventional two-prime cryptographic systems typically provide a processor and a single exponentiation unit communicatively coupled with the processor in order to reduce the burden on the processor and speed up the prime number generation process as further explained below. The exponentiation unit is typically an arithmetic logic unit (ALU). However, as further explained below, the computational performance of such systems is less than ideal.

In a traditional two-prime RSA system, the public modulus of length L is generated by multiplying two prime numbers, p and q, of approximately equal size. As the length L increases, the decryption process and the signature generation process (each of which involves the large private key exponent d) become computationally intensive. These two operations have computational time that increases as the cube of the modulus, L³. The Chinese Remainder Theorem (CRT) is commonly used to increase the performance of this traditional two-prime RSA system.

There are two major opportunities for increasing the performance of the classic two-prime RSA cryptosystem. The first is to choose the public key exponent e to be small. Commonly used values for e include e=3 and e=65,537 (the Fermat number). The second is to optimize the decryption operation by casting the single-decryption operation modulo N into a system of two linear equations modulo p and q, respectively, where n=p * q. If L is the length of the modulus n in bits, then decryption and signature generation require a computational time that increases as the cube of the length of the modulus, L³. In traditional two-prime RSA cryptosystems, using the Chinese Remainder Theorem allows decryption to be carried out as two fast exponentiation operations. Furthermore, special-purpose hardware may be used to allow these operations to be conducted in parallel. Simply looking at decryption as two exponentiation operations done modulo p and q on a single cryptographic engine allows a 4× increase in performance. If the processing system is designed for parallel processing, then an 8× increase in performance is possible. The computations for fast decryption using the CRT are illustrated in FIG. 1.

Cryptanalysis refers to techniques for deciphering encrypted data without prior knowledge of the keys being used. From the time a security scheme becomes publicly known and used, it is subjected to unrelenting attempts to break it. Security levels for encryption schemes are continually being raised in order to combat increasingly more intelligent cryptanalytic attacks.

Cryptanalysts are interested in discovering the cryptographic key D which is used to decrypt data than in merely discovering the contents of a single message. The most basic method of finding a decryption key is to try all possibilities by an exhaustive key search until the correct key is found. One method for increasing the security level provided by a public key cryptography system is to increase the length L (i.e., size in bits) of the prime factors p and q so that the prime factors p and q cannot be found by an exhaustive search. As an example, very large modular numbers having a long length L (e.g., on the order of 512 bits, 768 bits, 1024 bits, and 2048 bits) are now being used to provide cryptographic keys. In the classic 2-prime RSA encryption algorithm, each of the prime factors p and q has a length Lₚᵣᵢₘₑ which is equal to half the bit length L of the modulus n. For example, if the modulus has a length L of 1024 bits, then each of the prime factors p and q would have a length Lₚᵣᵢₘₑ of 512 bits. Using cryptographic keys of this size requires a significant amount of computer resources to perform the encryption and decryption operations.

There are several tradeoffs required with current RSA implementations, including an increasing need to identify ways to speed up the computation while retaining security. The amount of computer processing power required to perform the encryption and decryption processes increases as the lengths of the prime factors increases. For security reasons, it is not unusual to find RSA systems proposed wherein the prime numbers p and q are on the order of 1024 bits long. (See R. L. Rivest, A. Shamir, and L. Adelman, “A Method for Obtaining Digital Signatures and Public-Key Cryptosystems,” Communications of the ACM, 12(2):120-126, February 1978.) This makes the modulus (product of p and q) a number with a 2048-bit representation. Numbers of this size require enormous computer resources to perform the signature generation, encryption, and decryption processes because the time to do these operations increases as the cube of the modulus size. The encryption processing can be limited by using a small encryption exponent. The signature generation and decryption time can be speeded up using the CRT.

There is a commercial need for longer and longer moduli due to incremental improvements in factoring techniques and ever-faster networks of computers being made available to break ciphertext. These large networks of computers will continue to be mobilized to attack the RSA system, resulting in the use of larger moduli. This increasing need for security (larger moduli) in the RSA system is in conflict with the desire for higher and higher performance. There is a requirement to identify ways to speed up the computation while retaining security. (See RSA Factoring Challenge, RSA Laboratories' announced results for RSA-155 challenge on Aug. 26, 1999.) This performance problem is also exacerbated as the volume of ciphertext messages requiring decryption or signature generation increases, such as can be found in e-commerce transactions using the internet. For example, a financial institution might maintain an Internet site that could receive hundreds of enciphered and digitally signed transactions every second. The messages associated with each of these transactions must be processed and responded to in a timely manner. Securing these transactions with an RSA system using large primes to form the keys can impose severe limitations on the institution's ability to produce a timely response.

Several ideas have been introduced for increasing performance while retaining security. For example, Adi Shamir introduced “unbalanced RSA” for short messages. (See A. Shamir, “RSA for Paranoids,” Cryptobytes 1.3 Autumn.)

### Multi-Prime Technology

Another example of a public key cryptography is the Multiprime extension of the RSA system, which is described in U.S. patent application Ser. No. 09/328,726, filed on Oct. 26, 1998, by Collins et al. U.S. patent application Ser. No. 09/328,726 describes a CRT implementation using a plurality of k prime factors with an equal number k of exponentiators operating in parallel. Instead of a modulus of n=p * q, as in the traditional RSA system, the MultiPrime technology-based cryptosystem uses a modulus wherein n is developed as a plurality of k distinct prime numbers: n=p₁* p₂ * . . . * pₖ, wherein k is an integer greater than 2. If p and q are 512-bit numbers, then N=p * q is 1024 bits. In a MultiPrime system, p₁, p₂, p₃, and p₄ of 256 bits will also result in a 1024-bit modulus.

It is important to note that a sender of an encrypted message is not affected if the recipient chooses to use more than two prime factors to form the modulus N. The sender is not affected if the recipient chooses more than two primes to form N. If a recipient chooses to use four primes, then the sender's computations do not change. The sender is not aware that the recipients modulus consists of more than two primes or whether he chooses to use the Chinese remainder theorem.

The Multi-Prime cryptosystem offers significant performance advantages over the traditional two-prime RSA cryptographic system along with the ability to maintain a prescribed level of security. The MultiPrime cryptosystem also relies on the difficulty of factoring a composite into its constituent prime factors. In accordance with the Multi-Prime cryptographic scheme, a public key E (including a composite number n and a public exponent e) is determined. A plurality of k (wherein k is an integer greater than 2) random large, distinct prime numbers, p₁, p₂, . . . pₖ are developed and checked to ensure that each of (p₁−1), (p₂−1), . . . , and (pₖ−1) is relatively prime to the number e. Preferably, the prime numbers p₁, p₂, . . . pₖ are of an equal length Lₚᵣᵢₘₑ in bits. However, the system allows for some asymmetry in that the length of the prime numbers may be unequal. Then, the composite number n is defined in accordance with relationship (7) below,

n=p₁·p₂·. . . pₖ (7)

The composite number n provides a modulus for encoding and decoding operations. The prime numbers p₁, p₂, . . . pₖ must satisfy the criteria of being distinct, random, and suitable for use in the Multi-Prime cryptographic system.

In order to be distinct, the prime numbers pᵢ=p₁, p₂, . . . pₖ must satisfy constraint (8), below.

pᵢ≠pⱼ for i≠j (8)

In order to be random, each of the prime numbers pᵢ=p₁, p₂, . . . pₖ must be statistically independent, that is the prime numbers must satisfy the constraint (9), below.

pᵢpⱼ for i≠j (9)

In order to be suitable for use in the Multi-Prime cryptographic system, the prime numbers pᵢ=pᵢ, p₂, . . . pₖ must satisfy the constraints (10) and (11), below.

2^{L-1}<p₁·p₂·. . . ·pₖ<2^{L} (10),

and

e does not divide into pᵢ−1 (11)

Stated alternatively, constraint (11) requires that each prime pᵢ must satisfy the relationship; GCD(e, (pᵢ−1))=1. This constraint requires that the public exponent e and (pᵢ−1) be relatively prime. If the public exponent e and (pᵢ−1) have a common divisor greater than 1, then pᵢ must be rejected as a key prime.

It is also noted here that there is another constraint on the prime factors which may be considered for use in the RSA cryptographic system. This constraint is reflected in the linear congruency of relationship (12), below.

c·d≡1 modφ(n) (12)

where φ(n) is Euler's totient function. Here, d is the private exponent and is the multiplicative inverse of e mod φ(n) where e is the public exponent. The Totient function may be expressed in accordance with relationship (13), below.

φ(n)=(p₁−1)·(p₂−1) . . . ·(pₖ−1) (13)

where n=p₁·p₂·. . . pₖ .

The linear congruency of relationship (12), above has a unique solution d if and only if GCD(e, φ(n))=1. That is, the public exponent e must be relatively prime to φ(n). This means that e must not be a divisor of (p₁−1) or (p₂−1) . . . or (pₖ−1)

A decryption key D, including the composite number n and the private exponent d, is established in accordance with relationship (14), below

d≡e⁻¹ mod ((p₁−1) (p₂−1) . . . (pₖ−1)) (14)

In the most common application of the Multi-prime cryptographic scheme, a plaintext message M is encoded to ciphertext C by an encoding process using the public key E wherein the prime factors p₁, p₂, . . . pₖ are not known by the sender. In this application, the encoding process of the multi-prime scheme is performed in accordance with relationship (2), reprinted below.

C≡M^{e} (mod n), (2)

wherein

0≦M≦n−1,

The decoding process of the Multi-Prime scheme provides for decoding the ciphertext word C to a receive message word M′. The decoding step is usually performed using the private exponent d as a decryption exponent that is defined by relationship (15) below.

d≡e⁻¹ mod ((p₁−1)(p₂−1) . . . (pₖ−1)), (15)

The Multi-prime cryptographic decoding process includes a first step of defining a plurality of k decryption sub-tasks in accordance with relationships (16) below.

M₁′≡C₁^{d1} (mod p₁),

M₂′≡C₂^{d2} (mod p₂),

.

.

.

Mₖ′≡Cₖ^{dk} (mod pₖ),

wherein

C₁≡C (mod p₁),

C₂≡C (mod p₂),

Cₖ≡C (mod pₖ),

d₁≡d (mod (p₁−1)),

d₂≡d (mod (p₂−1)), and

dₖ≡d (mod (pₖ−1)) (16)

The values d₁, d₂. . . dₖ are referred to as sub-task private components. The above recited sub-tasks are then solved to determine results M₁′, M₂′, . . . Mₖ′ which are subsequently combined in accordance with a combining process to produce the receive message word M′, whereby M′=M.

The Chinese Remainder Theorem provides a mathematical proof which proves the existence of a unique solution to the sub-tasks described in accordance with relationships (16) above. There are many different forms of Chinese Remainder Algorithms which may be used to solve these sub-tasks.

U.S. patent application Ser. No. 09/328,726 teaches the use of either a recursive type of Chinese Remainder Algorithm (CRA) combining process or a summation type CRA combining process for combining the results M₁′, M₂′_{. . .} , Mₖ′ to produce the receive message word M′.

A recursive (or iterative) type of CRA combining process may be performed in accordance with relationship (17), below.

Yᵢ≡Yᵢ₋₁+[(M_{i′-}Yᵢ₋₁)(wᵢ⁻¹ mod pᵢ) mod pᵢ]·wᵢ mod n, (17)

wherein 2≦i≦k, and

$$M = {Y}_{k} , {Y}_{1} = {M}_{1} , and {w}_{i} = {\prod }_{j < i} {p}_{j} .$$

A summation type of CRA process may be performed in accordance with relationship (18), below.

$${M}^{′} ≡ {\sum }_{i = 1}^{k} {M}_{i}^{′} ( {w}_{i}^{- 1} mod {p}_{i} ) {w}_{i} mod n , where {w}_{i} = {\prod }_{j \neq i} {p}_{j} . \qquad ( 18 )$$

The values Wᵢ and Wᵢ⁻¹ are referred to as Chinese Remainder Algorithm coefficients.

Because each of the relationships (14) through (18) define at least one exponentiation, a large amount of time and processing resources are required to execute instructions associated with relationships (14) through (18) in order to implement Multi-prime encryption and/or decryption processes. In order to accelerate the encryption and/or decryption processes, U.S. patent application Ser. No. 09/328,726 describes a cryptographic system including a processor and an array of exponentiation units communicatively coupled with the processor in order to reduce the burden on the processor and speed up the encryption and/or decryption processes as further explained below.

FIG. 2 shows a block diagram generally illustrating an exemplary Multi-Prime cryptographic system architecture at 10. The system architecture 10 includes a parallel processing Multi-Prime cryptographic system 12 that is adapted for use with a larger processing system (not shown) that may provide requests to the system 12 via a bus 16, the requests specifying execution of encryption and/or decryption functions. The system 12 is responsive to such requests, and operative to generate encrypted on decrypted values. The system 12 includes: a processor subsystem 18 communicatively with the bus 16 via a bus interface 20; and an array 24 of exponentiation units 26 each being communicatively coupled with the processor subsystem 18 via an input/output (I/O) bus 28, and being operative to execute exponentiation operations as further explained below. The processor subsystem 18 includes: a processing unit 32 communicatively coupled with the bus interface 20; a local secure memory unit 34 communicatively coupled with the processing unit 32 via a data/address bus 36; and a data encryption standard (DES) unit 38 for encrypting pre-computed cryptographic parameters to be stored outside of the security boundary of the processor subsystem 18. The local secure memory unit 34 provides for storing pre-computed cryptographic parameters, and also for storing cryptographic keys for deciphering encrypted pre-computed cryptographic parameters stored outside of the security boundary of the SMPG unit.

As an example of the extension of the CRT implementation to MultiPrime technology, consider that n=p₁ * p₂ * p₃. With reference back to FIG. 1, an easy visualization of a CRT system with two parallel exponentiators would involve breaking it into two problems. That is, consider one problem modulo p₁ corresponding to the left branch of FIG. 1. The second problem can be done modulo p₂ * p₃ because CRT only requires that p₁ be relatively prime to p₂ * p₃. This second problem corresponds to the right-hand side of FIG. 1. Clearly, the right-hand side of this modified procedure in FIG. 1 in turn can be broken again into two problems. The result is a recursive relation that is satisfied by three recursions—the number of recursions is equal to the number of primes. Decryption of the ciphertext, C, using the relationship (2), above, is used to develop the following decryption subtasks:

C₁≡C mod p₁

C₂≡C mod p₂

C3≡C mod p₃

d₁≡d mod (p₁−1)

d₂≡d mod (p₂−1)

d₃≡d mod (p₃−1)

M₁≡C₁^{d1} mod p₁

M₂≡C₂^{d2} mod p₂

M₃≡C₃^{d3} mod p₃

As mentioned above, the results of each subtask (M₁, M₂, and M₃) can be combined to produce the plaintext, M, by a number of techniques. A recursive form of the CRT reconstruction is preferred. The following is a recursive CRT algorithm for computing the plaintext message, M=C_{d} (mod N) where N=p[1] * p[2] * . . . p[m]:

Let q[1]=1;q[i]=q[i−1]* p[i−1], for i=2,3, . . . , m

Then,

u[i]=q[i]⁻¹ mod p[i], for i=2,3, . . . , m

x[i]=d[i]⁻¹ mod (p[i]−1), for i=1,2, . . . , m

g[i]=C mod (p[i]−1), for i=1,2, . . . , m

a[i]=g[i]^{x[i]}mod p[i], for i=1,2, . . . , m

y[1]=a[1];

y[i]=y[i−1]+q[i]* ((a[i]−y[i−1])*u[i]mod p[i]), for i=2,3, . . . , m

M=y[m]

Therefore, the efficiency in cryptographic processing using MultiPrime technology is enhanced further by implementing CRT techniques and by using parallelism to evenly distribute the load across multiple exponentiators simultaneously.

### Comparison of Performance Between MultiPrime Technology and Traditional RSA

To compare MultiPrime system performance, a baseline system must first be established. Assume that the baseline system is an RSA two-prime system in which CRT is used and exponentiation is accomplished on a single processor or exponentiator.

The time to encrypt or decrypt in such a system increases as the cube of the modulus size, L³. Thus, the performance of the two-prime case on a single processor without CRT is proportional to L³. If CRT is used on a single cryptographic processor, then the time is proportional to (L/2)³+(L/2)³=L³/4.

First consider MultiPrime executing on a single exponentiator. If k primes are used and CRT is performed on the single exponentiator, then the time is proportional to L³/k². Therefore, the speedup of this MultiPrime system relative to the baseline system (normal two-prime RSA system using CRT) is on the order of k²/4. If three primes are used (k=3), then the speedup of the system is about 9/4, or 2.25 times.

If four primes are used, the increased performance is about 4×. This is a theoretical limit and ignores overhead including the CRT reconstruction.

Now consider MultiPrime technology executing on the system 10 (FIG. 2) having multiple exponentiators. The number of exponentiators is equal to the number of prime factors so all the CRT operations are accomplished in parallel. The time to accomplish k exponentiations simultaneously on k exponentiators is L³/K³. The theoretical speedup of a MultiPrime system with k exponentiators versus the baseline system using CRT on a single exponentiator is the ration of L³/4 to L³/k³ or k³/4. For k=3, the performance improvement will be a factor of 7. The performance enhancement is 16 for a MultiPrime system with four primes (k=4). Consider the following example of a 2048-bit modulus:

N1 is the product of two 1024-bit primes.

N2 is the product of four 512-bit primes.

N3 is the product of sixteen 128-bit primes.

The theoretical performance speedup as defined above for a MultiPrime system over a two-prime system is k³/4 so that N2 will run 16 times faster than N1. Similarly, N3 will run 1024 times faster than N1.

However, the security characteristics of these three systems are different because N3 may be susceptible to attack using “small factor” algorithms or techniques such as the elliptical curve method (ECM).

A discussion of the actual performance data running traditional RSA and MultiPrime technology is presented. Included are descriptions of the test system and test software as well as a discussion of the results using a Compaq ProLiant 6000 server and a Compaq ALX200 PCI Accelerator Card. All tests were performed on a ProLiant 6000 server with installed hardware including: 650 megabytes of RAM; Four 200-megahertz Intel™ Pentium® processors; 512 kilobytes of cache; and Microsoft® Windows® 2000 operating system.

All test values were the average of 10 different computations each performed for 10 iterations, for a total of 100 averaged times. All starting data used in the tests was retained in order to repeat the exact same test at a later date using either different hardware or different test software. An AXL200 PCI Accelerator Card was the hardware used for the exponential acceleration. Since the maximum modulus size for this card is 1024 bits, the traditional RSA computation in the hardware test was limited to using a 2048-bit modulus (with CRT).

The software application used to perform the MultiPrime proof-of-concept and to measure its performance was written in C using Microsoft Visual C++® development system, version 5.0, and compiled as a console application. Care was taken to ensure that the multi-threading aspects of the Windows operating system interfered as little as possible; for example, during tests, no data was scrolled to the console window or written to disk.

All key generation, prime searching, and big-integer computations used the RSA BSAFE 3.0 CMP math routines. The BSAFE prime.c file was altered to accommodate the MultiPrime technology techniques. The computational algorithm was to use the MultiPrime iterative recombination formula and iterate for two steps only when performing the RSA computation, and iterating it for three or more steps when performing the MultiPrime technology-based computation.

All timing data for the tests, as well as initial values, was stored in internal arrays within the program until it finished; then all of the data was written to a file. The timing results were formatted so that they were easy to input into Microsoft Excel for graphing.

FIG. 3 illustrates the composite results of many experiments driving the system, and shows the relative response time for four different cases including: relative response time at 52 for traditional RSA (using two primes) in software; relative response time for MultiPrime technology in software using 256- and 512- bit primes at 54 and 56 respectively; relative response time at 58 for traditional RSA (using two primes) in hardware; and relative response time for MultiPrime technology in hardware using 256- and 512-bit primes at 60 and 62 respectively.

All of the curves 52 through 62 in FIG. 3 plot relative response time against the modulus length in bits. In the case of MultiPrime technology, the number of primes is also given for the 256- and 512-bit prime cases. The reference for the response time (10⁰=1) is taken as the case for the traditional RSA in software with a modulus size of 512 bits.

The software test results were obtained by using a single host processor using multiple CRT passes depending upon the number of primes used. The hardware test results were obtained by using the AXL200 PCI Accelerator Card in conjunction with the host platform. The AXL200 PCI Accelerator Card with its multiple exponentiator chips uses parallel CRT for both traditional RSA and MultiPrime computations. When MultiPrime technology is employed, each exponentiator services a unique prime in parallel.

FIG. 3 demonstrates that MultiPrime technology is viable for both hardware and software. FIG. 3 shows that as you progress from the traditional RSA in software through MultiPrime technology in software, through traditional RSA in hardware, and, finally, through MultiPrime technology in hardware, the response curves continue to flatten out, in general, and become more horizontal. This indicates that the exponentiation time is being reduced consistent with the theoretical model discussed above. The curve at 52 (associated with RSA in software) is very close to the theoretical L³ dependence. The curve at 56 (associated with 512-bit MultiPrime technology in software) is very close to the L³/k³ relationship. For example, the speedup at a modulus of 2049 bits between RSA and 512-bit MultiPrime technology is k²/4=4 which is very close to the measured values for the 2048-bit modulus case. Note also that the response time decreases as the value of the primes decreases.

The contrast in performance between RSA and MultiPrime technology in hardware is not as pronounced as in software, but nevertheless is still significant. The difference is due to the fact that RSA in hardware is already accelerated and each hardware exponent chip has its own specific characteristics that tend to differ from the theoretical results. The performance curve of the SMS311 custom application-specific integrated circuit (ASIC) chip tends to be more linear than that of software. Notwithstanding, the performance improvement is still achieved, especially using larger moduli. Another characteristic of the MultiPrime curves is that they increase somewhat as a function of the modulus and as a function of the number of primes. Theoretically, these MultiPrime curves should be flat (horizontal) because for a constant modulus size, n number of primes are being executed in n number of exponentiators in parallel. What is occurring is that as the number of primes becomes large, the recursive CRT algorithm becomes a noticeable fraction of the overall MultiPrime calculation (overhead) and hence the slope of the MultiPrime curves increase. This is noticeable in both the hardware and software computations for large numbers of primes.

The curve at 58 (associated with traditional RSA in hardware) stops at the 2048-bit modulus point. This is due to the fact that the hardware chips have a limit of 1024-bit operation and in traditional two-prime CRT cannot go beyond two 1024-bit primes providing a modulus of 2048 bits. Only MultiPrime technology provides the extensibility to proceed to higher moduli without having to change the hardware technology.

So far, this description has presented the effects on exponentiation performance with respect to the size and number of primes without regard to the consideration of security, specifically to the factoring strength of the multiple primes. The present invention addresses the security limits of using MultiPrime technology.

There are several tradeoffs required with current RSA implementations, including an increasing need to identify ways to speed up the computation while retaining security. For a given modulus size, increasing the number of prime factors and using CRT with parallel exponentiators will increase performance of a Multi-Prime cryptographic system. However, as the size of these prime factors decreases, the modulus can be factored by a small fraction algorithm—for example, the Elliptic Curve Method (ECM). On the other hand, increasing the modulus size through additional prime factors will increase the runtime of the Number Field Sieve (NFS). However, the maximum number of primes for a given modulus size is limited by the computational complexity tradeoffs between the NFS factoring method and the ECM.

What is needed is a system and method for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a determined level of security.

### SUMMARY OF THE INVENTION

It is an object of the present invention to provide a system and method for determining an optimal number k of prime factors p₁, p₂. . . pₖ for developing a modulus N for use in a cryptographic system providing computational performance that increases as the number of constituent prime factors of the modulus increases, wherein use of the optimal number k of prime factors enables the system to provide optimal computational performance while maintaining a determined level of security.

Briefly, a presently preferred embodiment of the present invention provides a method for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a determined level of security.

The method includes the steps of: receiving information indicating a specified size of a modulus for use in a cryptographic system; determining a minimum security level commensurate with a minimum level of execution effort required to factor a modulus of the specified size; determining a security level associated with each of a predetermined range of integer numbers of prime factors constituting a modulus of the specified size, each security level being commensurate with a minimum level of execution effort required to factor a modulus of the specified size and having the associated number of constituent prime factors; and determining an optimal number k of prime factors that is the largest one of the range of possible numbers that is associated with a security level that is greater than or equal to the minimum security level.

In one embodiment, the step of determining a minimum security level includes determining a minimum security level commensurate with a minimum level of execution effort required to factor a modulus of the specified size and having two constituent prime factors using a number field sieve factoring method.

In one embodiment, the step of determining a security level associated with each of the predetermined range of integer numbers includes determining, for each of the predetermined range of integer numbers of prime factors, an associated security level commensurate with a minimum level of execution effort required to factor a modulus of the specified size and having the possible number of constituent prime factors using a plurality of different factoring methods.

In another embodiment, the step of determining a security level associated with each of the predetermined range of integer numbers includes determining, for each of the predetermined range of integer numbers of prime factors, an associated security level commensurate with a minimum level of execution effort required to factor a modulus of the specified size and having the possible number of constituent prime factors using a small factor algorithm. In one embodiment, the small factor algorithm is an elliptical curve method of factoring.

An important advantage of the system and method of the present invention is that use of the optimal number k of prime factors in a Multi-Prime cryptographic system enables the system to provide optimal computational performance while maintaining a determined level of security.

In an alternative embodiment of the present invention, a level of security is specified as the input to the process, rather then the modulus.

The foregoing and other objects, features, and advantages of the present invention will be apparent from the following detailed description of the preferred embodiment which makes reference to the several figures of the drawing.

### IN THE DRAWING

FIG. 1 is a block diagram generally illustrating a fast RSA decryption process using the Chinese Remainder Theorem;

FIG. 2 is a block diagram generally illustrating an exemplary Multi-Prime cryptographic system including an array of exponentiation units for executing a decryption process in a parallel processing environment;

FIG. 3 is a graph illustrating comparisons between the performances of various types of Multi-Prime cryptographic systems and traditional two-prime RSA cryptographic systems;

FIG. 4 is a graph illustrating elliptical curve method (ECM) and number field sieve (NFS) work factors for a 1024-bit modulus consisting of 2 to 15 prime factors;

FIG. 5 is a graph illustrating ECM and NFS work factors for a 2048-bit modulus consisting of 2 to 15 prime factors;

FIG. 6 is a graph illustrating ECM and NFS work factors for a 4096-bit modulus consisting of 2 to 15 prime factors;

FIG. 7 is a flow diagram illustrating a method in accordance with the present invention for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a specified level of security;

FIG. 8 is a table diagram illustrating optimal numbers of prime factors for developing different size moduli, the optimal numbers being determined in accordance with the method illustrated in the flow chart of FIG. 7;

FIG. 9 is a generalized block diagram illustrating a security application in accordance with an alternative embodiment of the present invention wherein a level of security is specified as the input to the process, rather then the size of the modulus; and

FIG. 10 is a flow diagram illustrating an alternative embodiment of a method in accordance with the present invention for determining an optimal number k of prime factors wherein a level of security is specified as the input to the process, rather then the size of the modulus.

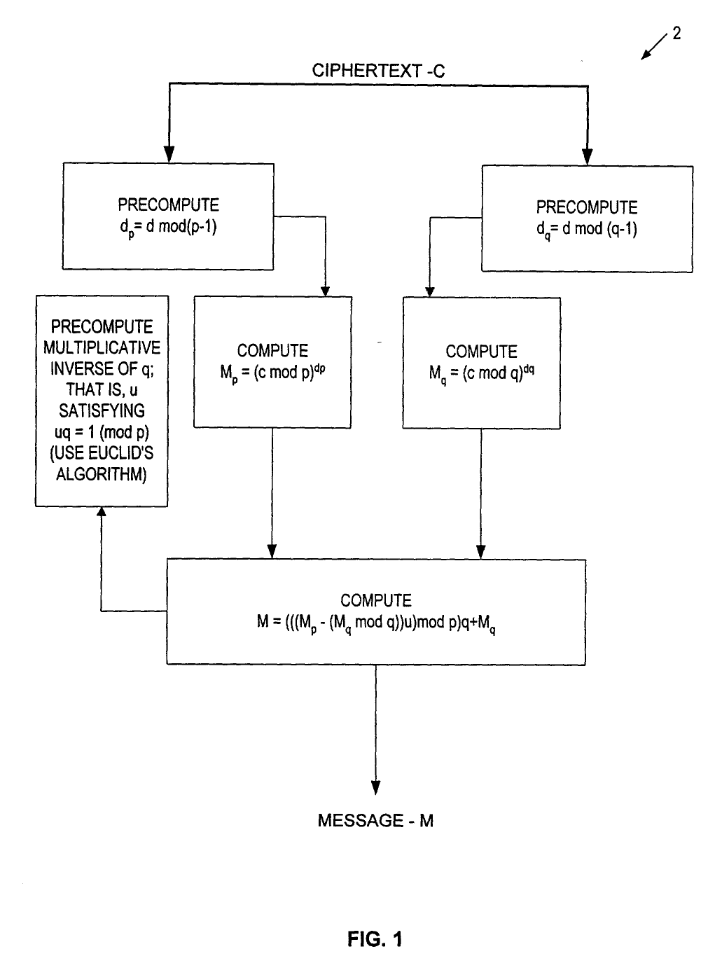

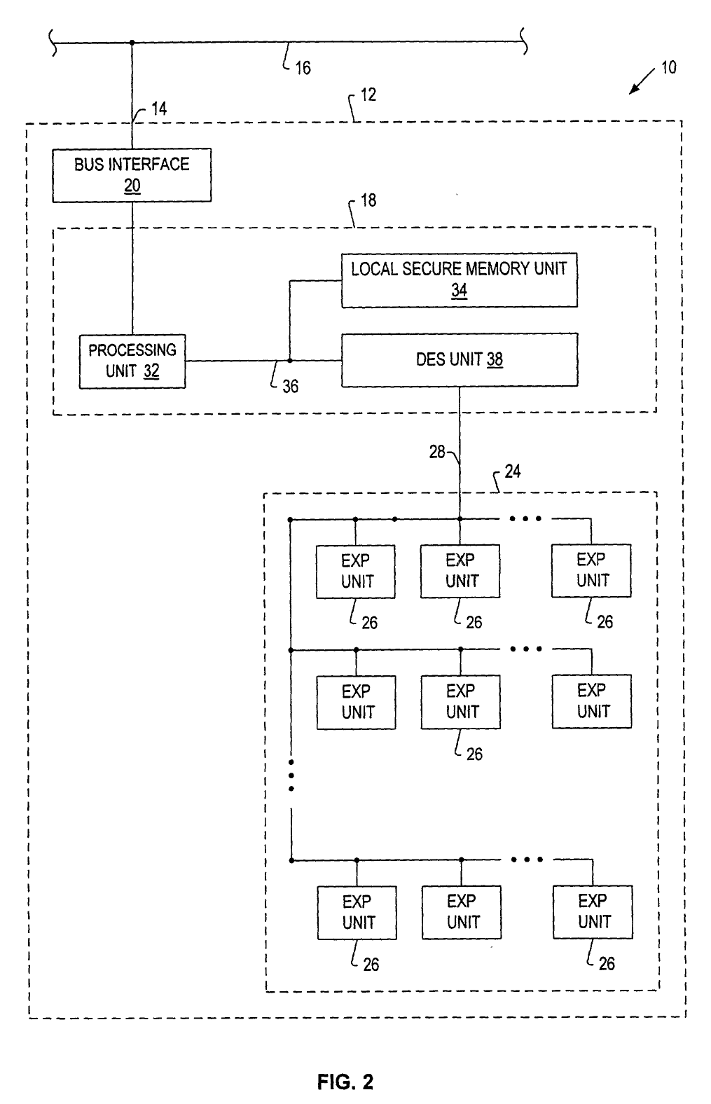

### DETAILED DESCRIPTION OF THE PREFERRED EMBODIMENTS

As explained above, MultiPrime cryptographic systems provide significant performance advantages over classic two-prime cryptographic systems. Also, the computational performance of MultiPrime cryptographic systems increases as the number of constituent prime factors of the modulus increases, particularly in a parallel processing environment as explained in detail above.

As described above, Multi-Prime technology adds a new dimension to the traditional security-versus-performance paradigm. Multi-Prime technology provides significant performance advantages while maintaining a prescribed level of security. In effect, MultiPrime technology allows users to trade off the modulus size and number of primes to increase performance and maintain the prescribed security level. A significant contrast was provided using parallelism, CRT, and multiple exponentiators processing a MultiPrime distributed task. An example of a 2048-bit modulus being reduced into eight 256-bit processes was provided to illustrate the speedup of a MultiPrime system. In this case, the performance increase was 40 times faster than with a system that computes the product of two 1024-bit primes. There are some security considerations in implementing this new technology. One key consideration is whether the primes are sufficiently large to achieve the security that one would attain using a modulus made up of two primes.

The number of prime factors, k, in a MultiPrime system can be expanded but at some point an issue arises as to whether the prime factors are sufficiently large to achieve the level of security expected of a modulus of a specified size that consists of two prime factors. An important issue is how the additional but smaller prime factors used in Multi-prime cryptographic systems affect the security of these systems. Another important issue involves the tradeoff being made between the enhanced performance and security in this system. The present invention addresses these issues and establishes a definitive process for selecting an optimal number of prime factors that enable the achievement of a prescribed level of security in a Multi-prime cryptographic system, wherein use of the optimal number k of prime factors enables the system to provide optimal computational performance while maintaining the prescribed level of security.

The level of security of any cryptographic system may be expressed in terms of the computational effort required for a cryptanalyst to decipher data encrypted by the system without prior knowledge of the encryption scheme. In Multi-prime cryptographic systems, deciphering of a target encrypted message requires knowledge of the prime factors constituting the modulus used to encrypt the message. Therefore, deciphering a target message that has been encrypted using a Multi-prime scheme without prior knowledge of the keys requires a cryptanalyst to perform a process for factoring the associated modulus into its constituent prime factors. Therefore, the level of execution effort required to decipher a Multi-prime encrypted message is proportional to the level of execution effort required to factor the associated modulus using a best factoring method.

There are many different types of factoring methods that may be used to factor a modulus consisting of a plurality of prime factors. The Number Field Sieve (NFS) is the best-known factoring method and is unaffected by the number of primes in the modulus used to encrypt the target message. The execution effort required to factor a modulus N using an NFS type computer implemented process can be expressed based on the time complexity function for NFS. The execution effort required to factor a modulus N using an NFS process may be expressed in MIPS-Years in accordance with relationship (19) below.

No. of MIPS-Years=1.5·10⁻⁵ exp[1.923 {cube root}\sqrt{log N(loglogN)²}] (19)

wherein a MIPS-Year is a number of computer instructions executed in one year by a computer operating at one million instructions per second.

The time complexity factor for the number field sieve method has been described by: R. Shroppel, private communication, August 1999; and by S. A. VanStone, A. J. Menezes, and P. C. Van Oerecht, Handbook of Applied Cryptography, CRC Press, New York, 1997.

The runtime of the NFS process depends on the size of the modulus n=p_{i*} p_{2*} . . . pₖ and is independent of the size Lₚᵣᵢₘₑ of the individual prime factors pᵢ, p₂, . . . pₖ. It is important to recognize that an NFS process does not run faster as the lengths of the primes decrease.

As examples, consider that: a first 2048-bit modulus N1 is the product of two 1024-bit primes; a second 2048-bit modulus N2 is the product of four 512-bit primes; and a third 2048-bit modulus N3 is the product of sixteen 128-bit primes.

The time complexity of the NFS process is the same for N1, N2, and N3. However, the impact of “small-factor algorithms” such as the Elliptic Curve Methods (ECM) must be considered. This class of factoring algorithms has a runtime that depends on the size of the prime factors such that the larger the prime factors, the greater the time complexity of this class of algorithms. In general, the largest factor that has been found using ECM algorithms is a 166-bit factor (50 digits). The third 2048-bit modulus N3 (the product of sixteen 128-bit primes) is the product of too many small primes and is susceptible to factoring by ECM algorithms. The modulus N2 (consisting of four 512-bit primes) is more secure than N3. Some security criteria must be specified before a maximum number of prime factors can be established.

The time for finding a prime number having a binary length P for use as a factor of a modulus with D decimal digits using an ECM algorithm may be expressed in accordance with relationship (20) below.

No. of MIPS-Years=3·10⁻¹⁵ D² exp({square root over (2log P log log P))} (20)

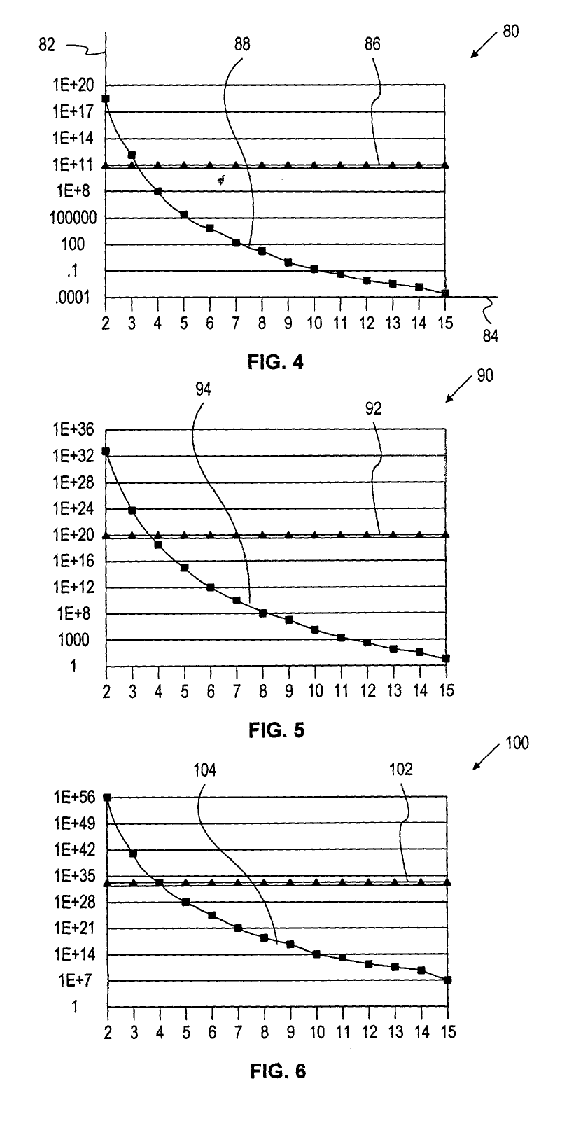

FIGS. 4, 5, and 6 show ECM and NFS work factors for 1024-, 2048-, and 4096-bit moduli. FIG. 4 shows a graph illustrating work factors, or levels of execution effort, (plotted on a first axis 82) required to factor a 1024-bit modulus having a varying number of constituent prime factors (the number of prime factors being plotted on a second axis 84). A first curve 86 illustrates that the level of execution effort required to factor a 1024-bit modulus having 2-15 constituent prime factors using the number field sieve method does not vary as the number of prime factors increases. A second curve at 88 illustrates that the level of execution effort required to factor a 1024-bit modulus having 2-15 constituent prime factors using an ECM algorithm decreases as the number of prime factors increases. Thus the security of a Multiprime cryptographic system decreases as the number of prime factors constituting the modulus increases.

FIG. 5 shows a graph at 90 illustrating work factors required to factor a 2048-bit modulus having a varying number of constituent prime factors. A first curve 92 illustrates that the level of execution effort required to factor a 2048-bit modulus having 2-15 constituent prime factors using the NFS method does not vary as the number of prime factors increases. A second curve at 94 illustrates that the level of execution effort required to factor a 2048-bit modulus having 2-15 constituent prime factors using an ECM decreases process as the number of constituent prime factors of the modulus increases.

FIG. 6 shows a graph at 100 illustrating work factors required to factor a 4096-bit modulus having a varying number of constituent prime factors. A first curve 102 illustrates that the level of execution effort required to factor a 4096-bit modulus having 2-15 constituent prime factors using the NFS method does not vary as the number of prime factors increases. A second curve at 104 illustrates that the level of execution effort required to factor a 4096-bit modulus having 2-15 constituent prime factors using an ECM process decreases as the number of prime factors increases.

The curves in each of the FIGS. 4 through 6 show a crossover point at which the computational work factor of the NFS and ECM factoring methods are equal. Choosing such a crossover point to establish a maximum number of primes to be used for a specific modulus size provides a conservative criterion with the result that the optimal number of primes is the maximum number such that the runtime of the ECM process is equal to or greater than the runtime of the NFS process. Note that such a crossover point only establishes a maximum number of primes when considering the NFS and ECM factoring methods. Other factoring methods may be developed. As further explained below, the system and method of the present invention provides more general criteria for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a determined level of security.

The below equations provide a more detailed explanation of one particular process of finding an optimal number of primes in accordance with equations (19) and (20), above.

### Representation of The Number Field Sieve Time to Factor

Let f_{NFS} (Lₙ, k)=f_{NFS} (L_{N}) be a function representing the effort required to factor a modulus N using the number field sieve method. Since f_{NFS} (L_{N}, k) is independent of the number of primes, k, one can write equation (19), reproduced below.

f_{NFS}(L_{N})=1.5·10⁻⁵ exp [1.923 {cube root}\sqrt{logN(loglogN)²}] (19)

where N is the size of the modulus expressed as N=2^{L}^{_{N}}

### Representation of Elliptic Curve Method (ECM) Time to Factor

The function f_{ECM} is a function representing the effort required to factor a modulus N using the ECM method.

f_{ECM}(L_{N}, k)=3·10⁻¹⁵D²exp [\sqrt{2log P(loglog P)}] (20)

where p=2^{L}^{_{N}}^{/k} (size of the Prime), D=Number of decimal digits in the Modulus, and L_{N} is the length of the binary representation of the modulus.

and where 2^{L}^{_{N}}=10^{D} or D=L_{N} log₁₀²

As seen in the graphical representation, the optimal number of primes is defined by the crossover point of the Number Field sieve and the Elliptic Curve factoring method.

From an analytical view, the k for which the crossover occurs is defined by the real number k* such that

f_{ECM}(L_{N}, k*)−f_{NFS}(L_{N})=0

Here f_{ECM}(L_{N}, k*) and f_{NFS}(L_{N}) are defined by equations 19 and 20. Therefore, for any size modulus, the optimal number of primes, k₀ is defined as the greatest integer less than or equal to k*. The present invention implements the analytic relations which compute k₀.

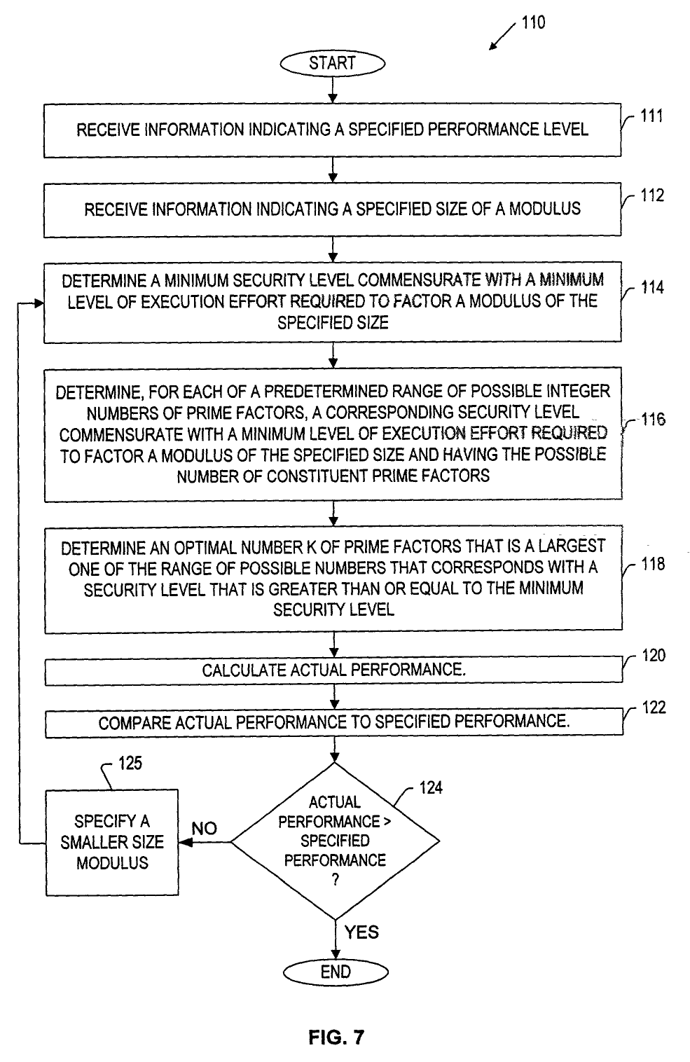

FIG. 7 shows a flow diagram illustrating a process at 110 in accordance with the present invention for determining an optimal number k of prime factors p₁, p₂, . . . pₖ for developing a modulus N for use in a cryptographic system providing computational performance that increases as the number of constituent prime factors of the modulus increases. Use of the optimal number of prime factors enables a Multi-Prime cryptographic system to provide optimal computational performance while maintaining a determined level of security.

The process 110 may be implemented by any type of computer system including: a memory unit (not shown); and a processing unit operative to execute computer readable instructions for executing the process 110. As well understood by those skilled in the art, the process 110 may also be implemented by a system including dedicated logic circuitry configured to implement the process 110.

The process 110 begins with a step 111 in which the system receives information indicating a user specified level of performance of a cryptographic system. The process proceeds to step 112 in which the system receives information indicating a specified size of a modulus for use in a cryptographic system. The size may be specified by a user or may be preselected in the system.

From step 112, the process proceeds to step 114 in which the system determines a minimum security level commensurate with a minimum level of execution effort required to factor a modulus of said specified size. In one embodiment, step 112 includes determining a minimum security level commensurate with a minimum level of execution effort required to factor a modulus of the specified size using a number field sieve factoring method. As an example, the first curve 86 (FIG. 4) illustrates that the minimum level of execution effort required to factor a 1024-bit modulus having 2 constituent prime factors using the NFS method is approximately 1E+11.

From step 114, the process proceeds to step 116 in which the system determines, for each of a predetermined range of possible integer numbers of prime factors, an associated security level commensurate with a maximum level of execution effort required to factor a modulus of said specified size and having said associated number of constituent prime factors. In one embodiment, step 116 includes determining, for each of the predetermined range of integer numbers of prime factors, an associated security level commensurate with a minimum level of execution effort required to factor a modulus of the specified size and having the possible number of constituent prime factors using a plurality of different factoring methods. In accordance with the present invention, the different factoring methods may include: any type of small factor algorithms such as the elliptical curve method (ECM); and any other type of factoring algorithm. Step 116 may be performed by solving equation (2) for MIPS years as a function of k=2 through k=16 assuming of course that p=n/k.

From step 116, the process proceeds to step 118 in which the system determines an optimal number k of prime factors that is a largest one of said range of possible numbers that corresponds with a security level that is greater than or equal to the minimum security level determined in step 112.

As an example, the first curve 86 (FIG. 4) illustrates that the minimum level of execution effort required to factor a 1024-bit modulus having 2 constituent prime factors using the NFS method is approximately 1E+11. FIG. 4 shows that k=3 is the largest of the illustrated range of numbers of prime factors (plotted on axis 84 of the graph of FIG. 4) that corresponds with a minimum security level (plotted along the curve 88 of FIG. 4 representing the associated levels of execution effort required to factor a 1024-bit modulus using the ECM algorithm) that is greater than or equal to 1E+11.

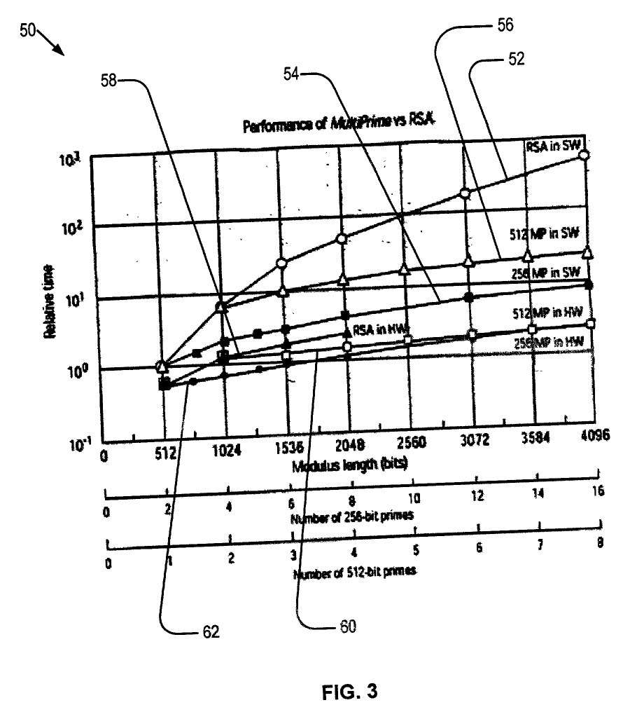

From step 118, the process proceeds to step 120 in which the system calculates actual performance as a function of the length of the modulus and number of primes. Actual performance may be calculated in step 120 in any of several different ways. As one example, actual performance may be calculated by use of a look up table derived from curves illustrated in FIG. 3 which were generated by actually running and measuring RSA multi-prime systems. As another example, actual performance may be calculated by actually timing the RSA performance such as by executing equation (3) and timing how long it takes to execute based on specified values for n, p, and k. As a last example, actual performance may be calculated by simulating performance as a function of the length of the modulus and number of primes.

From step 120, the process proceeds to step 122 in which the system compares the actual performance level, determined in step 120, to the performance level specified in step 111. The actual and specified levels of performance are specified as a time value indicating the amount of time required to perform an exponentiation (e.g., for decryption or signature generation). Therefore, a high performance level is indicated by a smaller amount of time.

From step 122, the process proceeds to 124 at which it is determined whether the actual performance is greater than the specified performance (less time required to do the actual performance), and if not, the process proceeds to 125 at which a smaller size modulus is specified after which the process proceeds to execute steps 114 through 124 again based on the smaller modulus size. Alternatively, if it is determined at 122 that the actual performance level is less than the specified performance level (more time required to do the actual performance), then the process ends.

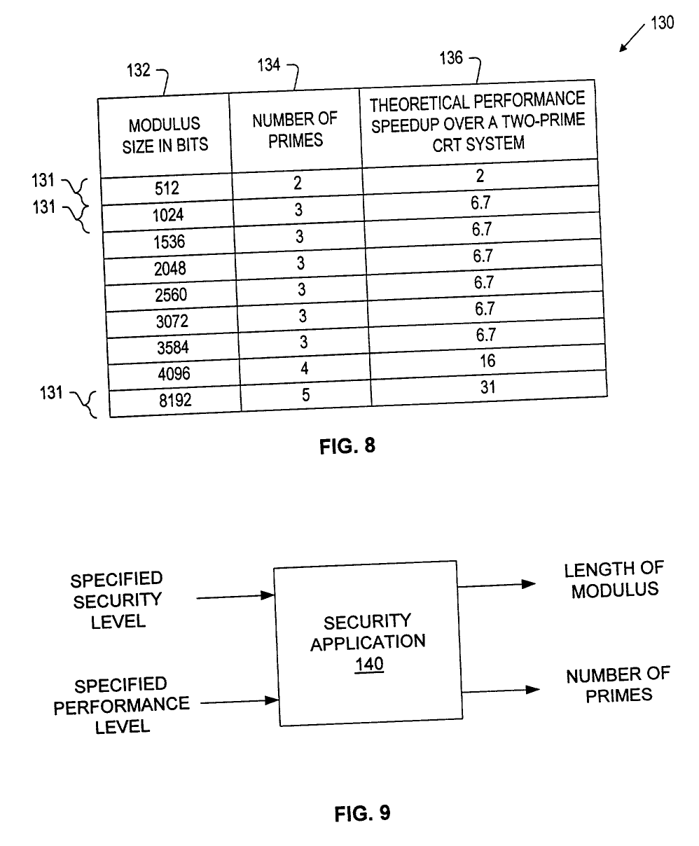

FIG. 8 shows a table diagram at 130 illustrating optimal numbers of prime factors (determined in accordance with the method illustrated in the flow chart of FIG. 7) for use in MultiPrime cryptographic systems using varying size moduli. The table 130 includes a plurality of entries 131 each including: an associated modulus size in bits displayed in a column 132; an associated optimal number of prime factors displayed in a column 134 for the associated modulus size; and an associated speedup value (indicating an associated theoretical performance speedup over a two-prime CRT system) displayed in a column 136 for the associated modulus size and optimal number of prime factors.

FIG. 9 shows a block diagram illustrating input and output parameters of a security application 140 in accordance with the present invention. The application 140 receives as input a specified security level and a specified performance level. The specified level of security may be expressed in the amount of time it would take to factor a modulus in order to break the cryptographic system (see, for example, the levels of security indicated on the vertical axes of FIGS. 4-6). The specified performance level may be expressed as an amount of time required to perform an exponentiation (e.g., for decryption or signature generation). Based on these specified parameters, the application provides an optimal length for an RSA multi-prime modulus, and an optimal number of prime factors for the modulus. The security application 140 calculates the length of a modulus n based on equation (19) using an iterative technique in accordance with standard mathematical procedures.

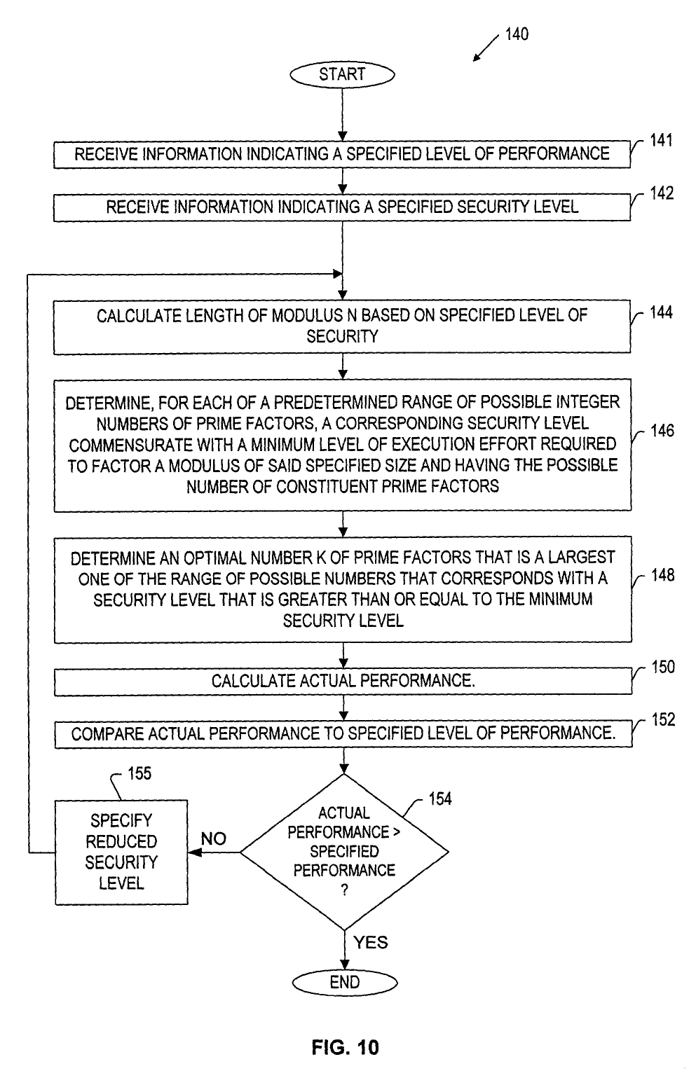

FIG. 10 shows a flow diagram illustrating a process at 140 in accordance with the present invention for determining an optimal number k of prime factors p₁, p₂, . . . pₖ for developing a modulus N for use in a cryptographic system providing computational performance that increases as the number of constituent prime factors of the modulus increases. Use of the optimal number of prime factors enables a Multi-Prime cryptographic system to provide optimal computational performance while maintaining a specified level of security.

The process 140 may be implemented by any type of computer system including: a memory unit (not shown); and a processing unit operative to execute computer readable instructions for executing the process 110. As well understood by those skilled in the art, the process 110 may also be implemented by a system including dedicated logic circuitry configured to implement the process 110.

The process 140 begins with a step 141 in which the system receives information indicating a user specified level of performance of a cryptographic system. The process proceeds to step 142 in which the system receives information indicating a specified level of security for the cryptographic system. From step 142, the process proceeds to step 144 in which the system calculates a length of a modulus n based on the level of security specified step 142. The calculation in step 142 may be performed based on equation (19) using an iterative technique in accordance with standard mathematical procedures

From step 144, the process proceeds to step 146 in which the system determines, for each of a predetermined range of possible integer numbers of prime factors, an associated security level commensurate with a maximum level of execution effort required to factor a modulus of said specified size and having said associated number of constituent prime factors. In one embodiment, step 146 includes determining, for each of the predetermined range of integer numbers of prime factors, an associated security level commensurate with a minimum level of execution effort required to factor a modulus of the specified size and having the possible number of constituent prime factors using a plurality of different factoring methods. In accordance with the present invention, the different factoring methods may include: any type of small factor algorithms such as the elliptical curve method (ECM); and any other type of factoring algorithm.

From step 146, the process proceeds to step 148 in which the system determines an optimal number k of prime factors that is a largest one of said range of possible numbers that corresponds with a security level that is greater than or equal to the minimum security level determined in step 142.

As an example, the first curve 86 (FIG. 4) illustrates that the minimum level of execution effort required to factor a 1024-bit modulus having 2 constituent prime factors using the NFS method is approximately 1E+11. FIG. 4 shows that k=3 is the largest of the illustrated range of numbers of prime factors (plotted on axis 84 of the graph of FIG. 4) that corresponds with a minimum security level (plotted along the curve 88 of FIG. 4 representing the associated levels of execution effort required to factor a 1024-bit modulus using the ECM algorithm) that is greater than or equal to 1E+11.

From step 148, the process proceeds to step 150 in which the system calculates actual performance as a function of the length of the modulus and number of primes. Actual performance may be calculated in step 150 in any of several different ways. As one example, actual performance may be calculated by use of a look up table derived from curves illustrated in FIG. 3 which were generated by actually running and measuring RSA multi-prime systems. As another example, actual performance may be calculated by actually timing the RSA performance such as by executing equation (3) and timing how long it takes to execute based on specified values for n, p, and k. As a last example, actual performance may be calculated by simulating performance as a function of the length of the modulus and number of primes.

From step 150, the process proceeds to step 152 in which the system compares the actual performance level, determined in step 150, to the performance level specified in step 141. The actual and specified levels of performance are specified as a time value indicating the amount of time required to perform an exponentiation (e.g., for decryption or signature generation). Therefore, a high performance level is indicated by a smaller amount of time.

From step 152, the process proceeds to 154 at which it is determined whether the actual performance is greater than the specified performance (less time required to do the actual performance), and if not, the process proceeds to 125 at which a smaller size modulus is specified after which the process proceeds to execute steps 144 through 154 again based on the smaller modulus size. Alternatively, if it is determined at 122 that the actual performance level is less than the specified performance level (more time required to do the actual performance), then the process ends.

Although the present invention has been particularly shown and described above with reference to a specific embodiment, it is anticipated that alterations and modifications thereof will no doubt become apparent to those skilled in the art. It is therefore intended that the following claims be interpreted as covering all such alterations and modifications as fall within the true spirit and scope of the invention.

What is claimed is:

1. A method for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a determined level of security, comprising the steps of:
a) receiving information indicating a specified size of a modulus for use in a cryptographic system;
b) determining a minimum security level commensurate with a minimum level of execution effort required to factor a modulus of said specified size;
c) determining a security level associated with each of a predetermined range of integer numbers of prime factors constituting a modulus of said specified size, each said security level being commensurate with a minimum level of execution effort required to factor a modulus of said specified size and having said associated number of constituent prime factors; and
d) determining an optimal number k of prime factors that is the largest one of said range of possible numbers that is associated with a security level that is greater than or equal to said minimum security level.

2. A method for determining an optimal number k of prime factors as recited in claim 1 wherein said step b) includes determining a minimum security level commensurate with a minimum level of execution effort required to factor a modulus of said specified size and having constituent prime factors using a number field sieve factoring method.

3. A method for determining an optimal number k of prime factors as recited in claim 1 said step c) includes determining, for each of the predetermined range of possible integer numbers of prime factors, an associated security level commensurate with a minimum level of execution effort required to factor a modulus of said specified size and having said possible number of constituent prime factors using a plurality of different factoring methods.

4. A method for determining an optimal number k of prime factors as recited in claim 1 wherein said step c) includes determining, for each of the predetermined range of possible integer numbers of prime factors, an associated security level commensurate with a minimum level of execution effort required to factor a modulus of said specified size and having said possible number of constituent prime factors using a small factor algorithm.

5. A method for determining an optimal number k of prime factors as recited in claim 4 wherein said small factor algorithm is an elliptical curve method of factoring.

6. A method for determining an optimal number k of prime factors as recited in claim 4 wherein said predetermined range of possible integer numbers includes integer numbers between 2 or greater.

7. An apparatus for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a determined level of security, comprising the steps of:
a) means for receiving information indicating a specified size of a modulus for use in a cryptographic system;
b) means for determining a minimum security level commensurate with a minimum level of execution effort required to factor a modulus of said specified size using a first factoring method;
c) means for determining a security level associated with each of a predetermined range of integer numbers of prime factors constituting a modulus of said specified size, each said security level being commensurate with a minimum level of execution effort required to factor a modulus of said specified size and having said associated number of constituent prime factors using at least one second factoring method; and
d) means for determining an optimal number k of prime factors that is a largest one of said range of possible numbers that is associated with a security level that is greater than or equal to said minimum security level.

8. An apparatus for determining an optimal number k of prime factors as recited in claim 7 wherein said first factoring method is a number field sieve factoring method.

9. An apparatus for determining an optimal number k of prime factors as recited in claim 7 wherein said second factoring method is a small factor algorithm.

10. An apparatus for determining an optimal number k of prime factors as recited in claim 9 wherein said small factor algorithm is an elliptical curve method of factoring.

11. An apparatus for determining an optimal number k of prime factors as recited in claim 7 wherein said predetermined range of possible integer numbers includes integer numbers between 2 or greater.

12. A method for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a determined level of security, comprising the steps of:
a) receiving information indicating a specified size of a modulus for use in a cryptographic system;
b) determining, for each of a predetermined range of integer numbers of prime factors, an associated first security level commensurate with a level of execution effort required to factor a modulus of said specified size and having said number of constituent prime factors using a first factoring method, said predetermined range of integer numbers including the integer number 2, each of said first security levels being substantially equal;
c) plotting on a graph a first set of points each representing one of said first security levels corresponding with one of said predetermined range of integer numbers;
d) fitting a first curve to said first set of points;
e) determining, for each of said predetermined range of integer numbers, an associated second security level commensurate with a level of execution effort required to factor a modulus of said specified size and having said number of constituent prime factors using a second factoring method;
f) plotting on said graph a second set of points each representing one of said second security levels corresponding with one of said predetermined range of integer numbers;
g) fitting a second curve to said second set of points;
h) determining a point of intersection between said first and second curves;
i) determining a threshold value representing a number of factors associated with said point of intersection;
d) determining an optimal number of prime factors that is a largest integer number less than said threshold value.

13. A method for determining an optimal number k of prime factors as recited in claim 12 wherein said first factoring method is a number field sieve method.

14. A method for determining an optimal number k of prime factors as recited in claim 12 wherein said second factoring method is an elliptical curve method of factoring.

15. A method for determining an optimal number k of prime factors p₁, p₂, . . . pₖ for developing a modulus N for use in a cryptographic system providing computational performance that increases as the number of constituent prime factors of the modulus increases, wherein use of the optimal number k of prime factors enables the system to provide optimal computational performance while maintaining a specified level of security, comprising the steps of:
a) receiving information indicating a specified level of security for a cryptographic system;
b) calculating a size of a modulus based on said specified level of security;
c) determining a security level associated with each of a predetermined range of integer numbers of prime factors constituting a modulus of said calculated size, each said security level being commensurate with a minimum level of execution effort required to factor a modulus of said calculated size and having said associated number of constituent prime factors; and
d) determining an optimal number k of prime factors that is a largest one of said range of possible numbers that is associated with a security level that is greater than or equal to said minimum security level.

16. A method for determining an optimal number k of prime factors as recited in claim 15 wherein said step b) includes determining a minimum security level commensurate with a minimum level of execution effort required to factor a modulus of said specified size and having constituent prime factors using a number field sieve factoring method.

17. A method for determining an optimal number k of prime factors as recited in claim 15 said step c) includes determining, for each of the predetermined range of possible integer numbers of prime factors, an associated security level commensurate with a minimum level of execution effort required to factor a modulus of said calculated size and having said possible number of constituent prime factors using a plurality of different factoring methods.
